(19) United States
(12) Patent Application Publication
(10) Pub. No.: US 2017/0070541 A1
(43) Pub. Date: Mar. 9, 2017

(54) CREATING COMMUNICATIONS SESSIONS IN A NETWORK PROVIDING FOCUSED INTERACTIONS AND MONETIZATION OF SELECTED COMMUNICATIONS

(71) Applicant: Chelsea Penner, Santa Monica, CA (US)

(72) Inventor: Chelsea Penner, Santa Monica, CA (US)

(21) Appl. No.: 14/846,767

(22) Filed: Sep. 5, 2015

(51) Int. Cl. H04L 29/06; G06Q 30/08; H04L 12/58

(52) U.S. Cl. CPC H04L 65/1069; H04L 51/32; G06Q 30/08

(57) ABSTRACT

A system creates communications in a social or other network to facilitate professional as well as social connections and interactions. A user registers in the system and enters selected information. Selected forms of interactions, each denominated as an event, may be constructed by users. A graphical user interface allows seekers of goods and services to interact with providers to complete formation of events. Users are categorized in accordance with a type of event. One event comprises a one-on-one meeting in which a user categorized as in influencer may monetize online presence with a focused reach.

### FIELD OF THE INVENTION

The present subject matter relates generally to creating communications sessions in a network and more particularly to creating directed interactions and monetizing selected communications.

### BACKGROUND

Social networks are provided for a variety of purposes. One common function is to match people who desire to meet other people. Other functions may be to provide online auctions or job searches. These functions are each essentially fixed in their respective methods of operation. Social networks may each have a membership fee. However, communications per se, apart from auction prices on auction networks, are generally not monetized.

U.S. Pat. No. 8,762,221 implements online reverse auctions in a social network platform. The network enables buyers to take advantage of a subscriber's network of friends and others. The network does not provide selectable interactions between buyers and objects of the auction.

U.S. Pat. No. 8,762,161 provides for visualization of interaction between users on a telephone network. This method provides for training models upon which relations between categories and relations between key phrases are determined. The network detects relationships but does not facilitate creating them.

U.S. Pat. No. 8,751,440 discloses classifying a relationship between a first group and each of one or more additional groups based on a number of communications during a time period. The frequency of communications increases the depth of interactions. However, the system does not provide for changing the nature of interactions.

United States Published Patent Application No. 20140316906 discloses systems and methods for identifying talent through online interaction. Songs are made available to critics such as members of the public via media such as the Internet. Feedback is provided and a winning talent may receive an award. This system does not take the interaction beyond the award.

United States Published Patent Application No. 20140222702 provides a database comprising member information for each of a plurality of members, including professional members and nonprofessional members. Activity information concerning interaction between the professional members is tracked. Search requests may be received in order to generate a list comprising the identified professional members. This system does not provide a matrix of selectable interactions between a selected professional member and a plurality of nonprofessional members.

United States Published Patent Application No. 20140201097 discloses a system and method for comparing individuals, relationships, and partners in a relationship and for providing relationship advice. This system does not provide for having one partner in a relationship counsel the other partner.

United States Published Patent Application No. 20140258159 discloses systems and methods of selecting a relevant user for introduction to a user in an online environment. A request may be received to identify a relevant user to be introduced to a participating user who is not yet connected to the relevant user in the social network based on social history records. The system may receive an indication from the participating user by interaction with a user device. The interaction is limited to defining a match between a relevant user and a participating user. Transactions do not occur.

United States Published Patent Application No. 20090171681 discloses an entertainer fan service providing electronic access to a fan on a network service. The fan may receive an access code providing electronic access. There is no procedure for providing a direct contact to one or to selected group of fans.

United States Published Patent Application No. 20070233514 discloses an introduction service to activate and facilitate community activities. A community management center searches for offered-service information that matches at least partly with an application designated by a coordinator terminal and selects participants specified by detected offered-service information, as introduction candidates. An introduction candidate list that describes private information, desired terms, and possessed value of ticket for each of the selected introduction candidates is provided. Interaction between the parties is not carried out on the network.

### SUMMARY

Briefly stated, in accordance with the present subject matter, a system is provided creating communications sessions in a network and more particularly to creating directed interactions and monetizing selected communications. The network may be a social network to facilitate professional as well as social connections and interactions. A user registers in the system and enters selected information. Selected forms of interactions are created. Each type of interaction is denominated as an event. A graphical user interface allows seekers of goods and services to interact with providers to complete formation of events. Users are categorized in accordance with a type of event. One event comprises a one-on-one meeting in which a user categorized as in influencer may monetize online presence with a focused reach. An event may enable professional as well as social connections.

Functions are tailored to particular needs. In one type of event, a member may bid for the opportunity to have an online meeting with a celebrity. A celebrity could be a recognized professional who is a key figure in popular discourse. This recognized professional is referred to herein as an influencer. The influencer gains the ability to focus connections on one member or a selected plurality of members. This is in contrast to social media providing indiscriminate connection with an indeterminate number of people. The auction, or a flat fee, provides a way for a celebrity to monetize connections and communications. A social network proprietor can interconnect to monitor communications in order to collect a commission on auction sales.

### BRIEF DESCRIPTION OF THE DRAWINGS

The present subject matter may be further understood by reference to the following description taken in connection with the following drawings:

FIG. 1 is a top level block diagram of a system incorporating the present subject matter and also serves as an illustration of the architecture for a non-transitory programmed medium to implement functions of the system;

FIG. 2 is an illustration of users seeking to establish an online connection;

FIG. 3, consisting of FIGS. 3A, 3B, 3C, and 3D, is an illustration of screens within a graphical user interface;

FIG. 4 is a flow chart illustrating the method and non-transitory machine-readable medium of the present system; and

FIG. 5, consisting of FIGS. 5A, 5B, 5C, and 5D, is an illustration of interactions of users with a further GUI providing access to a plurality of additional functions.

### DETAILED DESCRIPTION

In accordance with the present subject matter, an apparatus, method, and a non-transitory programmed medium for execution on a digital processor are provided. A social network is used to create communication sessions which enable professional as well as social connections. Functions are tailored to particular needs. For example, member users offer to pay for the opportunity to have an online meeting with an influencer. This provides the influencer with the ability to connect with one person or a selected plurality of people rather than having a form of communication subject to indiscriminate connection with an indeterminate number of people. An auction or a flat fee provides a way for the celebrity to monetize connections and communications. The social network proprietor can collect a commission on provision of communications.

In the present context, celebrities include any person who may have any sort of fan base. Fans connect with professional talent in such industries as entertainment, fashion, and music. A celebrity may be a musician who plays engagements at clubs and bars and who is not widely known. Operation of the present system financially empowers celebrities in allowing them to monetize their status. Celebrities may be influencers, i.e., key figures in popular discourse. The present system enables contact between selected system members with people in an “influencer/thought leader/celebrity” category.

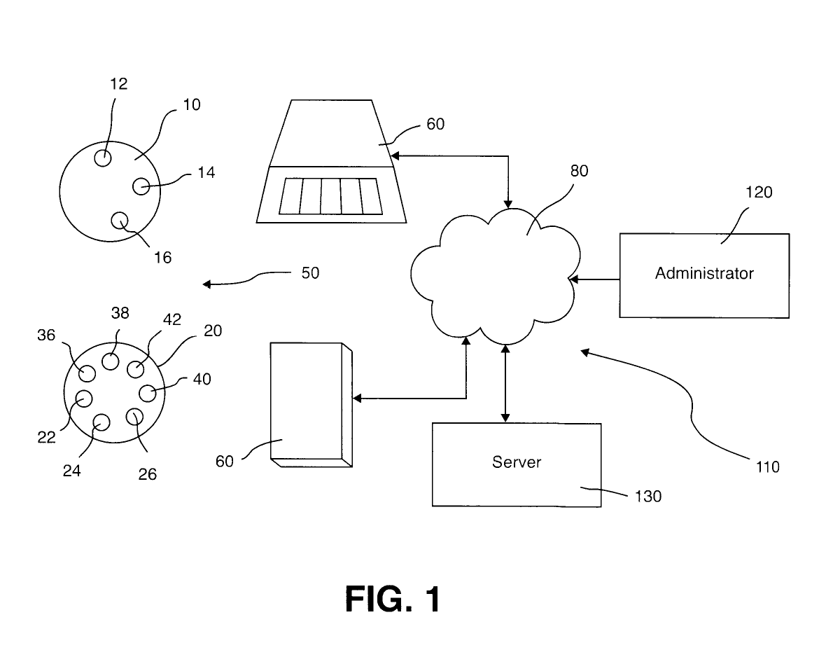

FIG. 1 is a top-level block diagram of a system incorporating the present subject matter and also serves as an illustration of the architecture for a non-transitory programmed medium to implement functions of the system. One significant part of the user population will comprise people looking for services, information, or opportunities for paid engagements. For purposes of the present description this part of the user population is referred to as seekers 10. Another significant part of the population will comprise those who are sought personally for advice or other communications, those who are sought for provision of services or goods, or those who provide opportunities for paid assignments to the seekers 10. For purposes of the present description, this portion of the population is referred to as providers 20.

Seekers 10 may take many different forms. For example, a fan 12 may be seeking to connect with a celebrity for the purpose of engaging in conversation. A member 14 may be seeking a provider 20 for coaching, tutoring, or other purposes. A freelancer 16 may be seeking hired engagements, networking, or other opportunities.

Providers 20 may comprise a celebrity 22, a supplier 24 of goods or services, or a talent hiring authority 26. Suppliers 24 may include mentors 36, acting or other coaches 38, sellers 40 of specialized professional equipment, or traditional service providers 42 such as accountants. Seekers 10 and providers 20 are collectively referred to as users 50.

The present subject matter provides a safe environment for freelancers 16. Many freelancers 16 work in fields where notorious abuse of job seekers takes place. For example, the modeling industry presents many potential pitfalls, including artist exploitation, sexual solicitation, underpay, underemployment, threat of being labeled unfavorably, and sexist treatment. The prior art systems do not provide time and incentive for legitimate mentors 36 to offer counseling to aspiring models.

A safe system is needed to provide a model or other freelancers 16 the environment and opportunity to proceed in a safe manner. In the general business environment, models may be typecast as lacking intelligence, presumed promiscuous, and assumed to be lacking in other valuable skills and abilities. The present system creates a closed environment in which the freelancer 16 may proceed safely into unknown territory. A talent hiring authority 26 who has a good-faith business model is presented with an environment in which the business model may be efficiently and profitably pursued and in which the talent hiring authority 26 does not have to lose a significant percentage of time in demonstrating that it is not nefarious.

Each of the seekers 10 and the providers 20 may communicate within a network system 100 via a digital device 60 via the Internet 80. The digital device may comprise a personal computer, a laptop, smart phone, tablet, or other device which may come into existence in the future.

The system 100 comprises a first social network 110, an administrator 120, and a central server 130. The components of the system 100 may be as shown. Alternatively, functions may be distributed among differing modules. The functions illustrated could also be embodied in a single server.

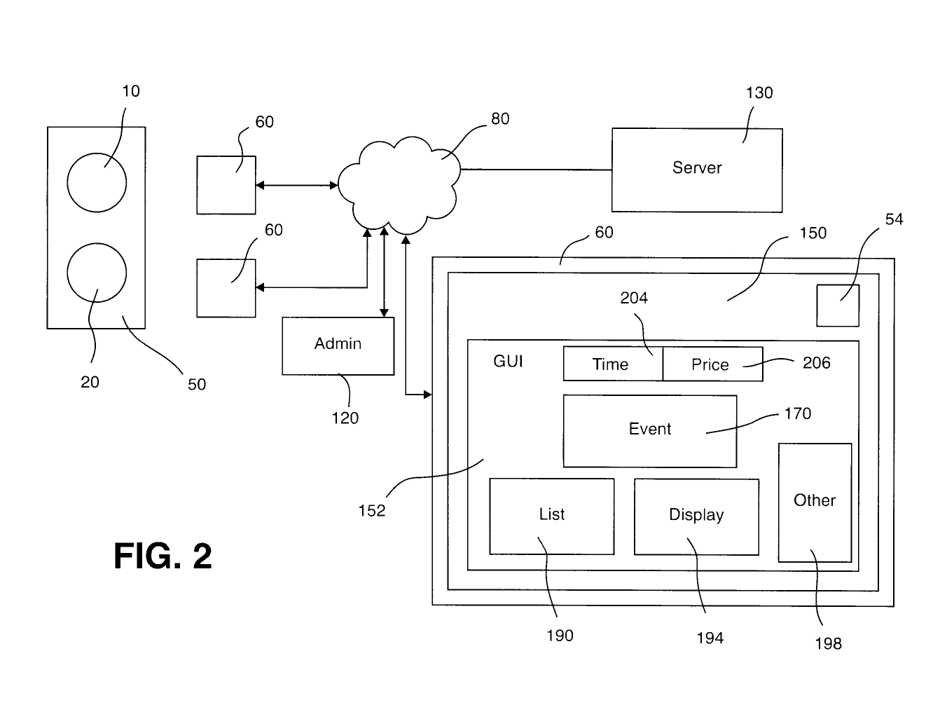

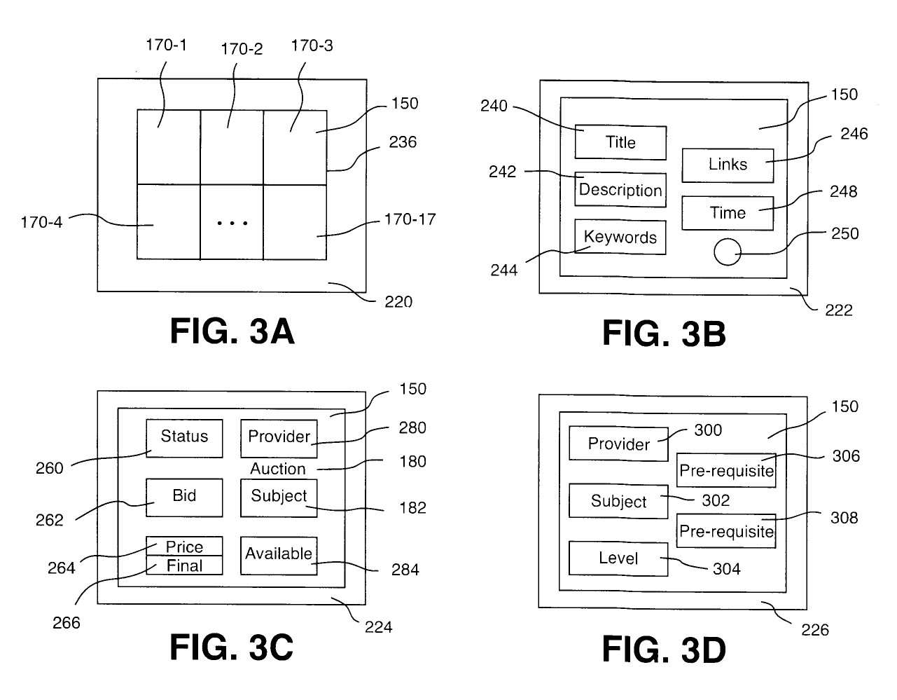

FIG. 2 is an illustration of users 50 who may each be seeking to establish an online connection. A user 50 communicates via a digital device 60 to the server 130, preferably by a graphical user interface (GUI) 150. In one embodiment, a first screen 152 of the GUI 150 may comprise an options menu. The users 50 participate in events, as described below with respect to FIG. 3. Additionally, a reporting facility 54 is provided whereby a user 30 may provide experience reports to the system administrator 120. Reports could include adverse experiences as to improper conduct or could include requests for customer service.

In one preferred form, users 50 participate in an event 170. An event is a communication between a first provider 20 or set of providers 20 and a first seeker 10 or a set of seekers 10. A fixed event 170 happens at a predetermined start time and end time. Beginning and end times of events 170 could also be mutually agreed to by users 50. An event 170 could have a fixed price. Alternatively, the event 170 could be the subject of an online auction 180 (FIG. 3C).

In one form, a provider 20 creates an event 170 and posts it to the system 100. The event 170 will comprise a communications session between selected categories of users. Parameters are created identifying whether there will be a fixed price or an auction price, times at which the offer will begin and end, a description of the event 170 and the provider 20, and search terms that may be used by seekers 10.

An event 170 could be a one-on-one communication. Communications may comprise consulting, tutoring, or simply a conversation with a provider 20.

The resources may comprise such items as a list 190 of celebrities, an events display 194, and other resources 198. In the present description, “celebrity” involves any individual or other entity that offers something to the seekers 10. An event 170 is a defined as communications session. Events include, for example, a meeting with a celebrity, whether for instruction or social communication. Other events could include an audition or a tutorial session. Other actions to be taken by seekers 10 could include requests for job interviews, consulting engagements, or individual assignments for performances, known as “gigs.”

A provider 20 may communicate with the server 130 in order to offer communication sessions and monetize the provider's status and time spent with fans or receivers of services. The system provides infrastructure for establishing an event 170. The event 170 could comprise a one-on-one meeting between the seeker 10 and the provider 20. The event 170 could comprise a webinar on a particular topic of interest to many users 50, or could comprise another form of contact. The event 170 may be shown on a display 204 of the time and duration of the event. A field 206 displays a price for the event. Rather than having a fixed price, the event 170 may be the subject of an auction among the seekers 12 (FIG. 1). In this case, the field 206 displays a current or final bid.

FIG. 3 consists of FIGS. 3A, 3B, 3C, and 3D illustrating screens 220, 222, 224, and 226 respectively. FIG. 3A is a screen 220 of the GUI 150 to allow users 50 to interact with respect to events 170. A chart 236 lists a plurality of events 170. Individual events are denoted 170-1 through 170-n, where n is an integer. Event 170-1 is a scheduled event for which a number of users 50 may register for a fixed price. Event 170-2 is a one-on-one session which will be granted to a seeker 10 making the highest bid at an online auction. The events 170-1 and 170-2 could each alternatively comprise a video event hosted by a provider 20. Event 170-3 is an event in which a mentor 36 is offering an event. A seeker 10 may contact the mentor 36 and request a mutually agreeable time for an online meeting.

In the present context a celebrity is someone whom the proprietor of the system permits to register as a celebrity. A celebrity may be a nationally known celebrity, a person known within a particular field, or a person known within a niche. For example, a niche personality could comprise an entertainer appearing regularly at a nightclub. Niches may include, for example, entertainment, sports, modeling, various genres of music, acting, dance, or professional fighting. Additional fields of endeavor include but are not limited to culinary arts, politics, online thought leaders, motivational speaking, fitness industry, and professional athletics such as professional basketball, football, or baseball.

FIG. 3B illustrates the screen 222 of the GUI 150 that is accessed when a user 50 selects the field 170-1 on the screen 220 of FIG. 3A. A field 240 lists a title. Field 242 is a complete description of the event 170-1, field 244 lists keywords, or search terms, field 246 provides links to details or to cross-referenced information. Field 248 lists a time for the event, and field 250 lists availability, including how many users 50 may purchase access to the event 170-1.

FIG. 3C illustrates the screen 224 that is accessed when a user 50 selects the field 170-2 on the screen 220 (FIG. 3A). Field 260 represents an auction status. Auction status may show when an auction will begin, if it is in progress, or if it has been completed. Field 262 lists a minimum bid increment. Field 264 lists a current auction price. Field 266 lists a final auction price.

Field 280 identifies the provider 20. Field 282 identifies one or more subjects that may be offered as the subject matter of the event 170-2. Field 284 lists availability of the event 170-2 and whether more than one event 170-2 is being offered.

FIG. 3D illustrates the screen 226 that is accessed when a user 50 selects the field 170-3. Field 300 lists the provider 20. Field 302 includes the subject of the event. Field 304 includes the level of the event in terms of, for example, beginner-intermediate-advanced. Field 306 lists prerequisites. Field 308 lists available times for which a seeker 10 may request an event 170-3. Field 308 allows the seeker 10 to enter information.

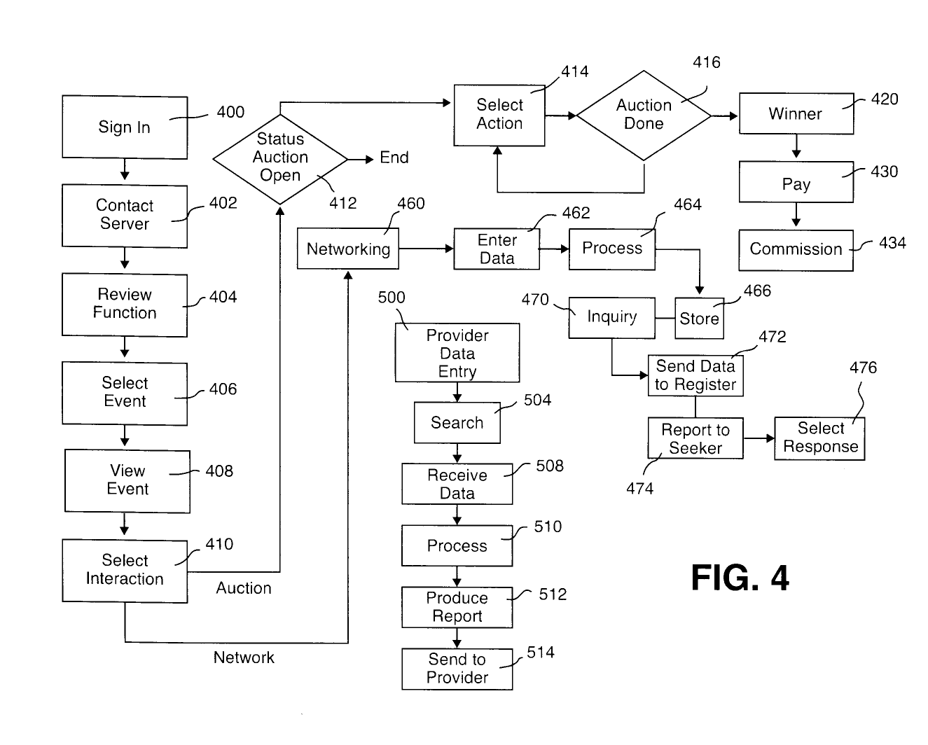

FIG. 4 is a flowchart illustrating performance and interaction of a social network. At block 400 a seeker 10 signs onto the system 100 (FIG. 1) and contacts the server 130 (FIG. 2) at block 402. The seeker 10 reviews available functions (FIG. 3A) at block 404. At block 406, the seeker 10 selects a particular event 170 and views that event at block 408. In this particular illustration, the event 170 is an auction event 170-2.

At block 410, the seeker 10 selects an interaction and reviews the status of the auction at block 412. The status comprises whether an auction has yet started or ended and a current price. If the auction is open to new entrants, then seeker 10 moves to block 414. If not, the process ends. At block 414, the seeker 10 selects an action, whether it be bidding or refraining from bidding. At block 416 the system determines if the auction has ended. If the auction is not over, operation returns to block 414 and proceeds to block 416. When the auction is over, a winning bidder is registered at block 420. Payment is processed at block 430, and a commission is sent to the administrator 120 (FIG. 2) at block 434.

At block 410, the seeker 10 may select a different function, for example, networking, and proceed to block 460 in response to the election. At block 462, a first seeker 10-1 enters data in response to the preselected questions. The data is processed at block 464 and stored in the server 130 at block 466. At block 462, a second seeker 10-2 enters data at block 460. The data is stored at block 466. This data may remain at rest until an inquiry is received at block 470. In response to the inquiry, data is accessed from the server 130 and provided for comparison to data entered from other users 50 at block 472. At block 474 a report is made to seeker 10-1 and to seeker 10-2. At block 476, seeker 10-1 and 10-2 may each respond to preselected options such as “connect” or “ignore.”

At block 500, a provider such as a casting director may enter a search for talent at block 504. The search for talent includes a search in server 130. At block 508, data is received from the server 130. The data is processed at block 510 in accordance with preselected criteria. The preselected criteria may include physical attributes, and ethnicity, work availability, and other characteristics for the particular job in question. At block 512, a report is produced. At block 514 the report is sent to the provider, e.g., the casting director.

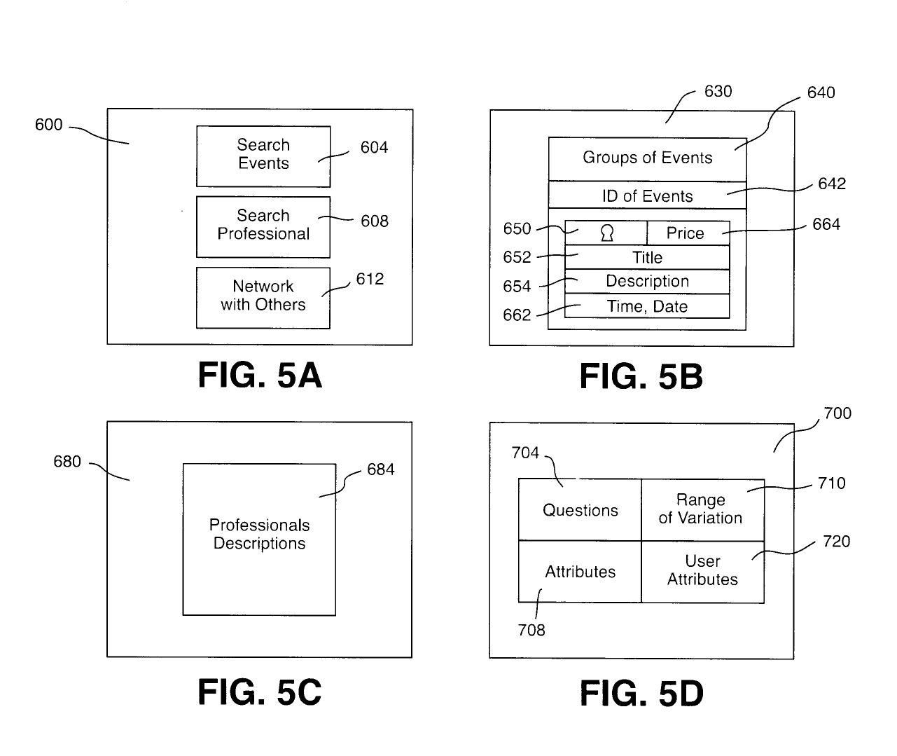

FIG. 5, consisting of FIGS. 5A, 5B, 5C, and 5D, illustrates interactions of users 50 with a further GUI providing access to a plurality of additional functions. FIG. 5A is an illustration of a screen 600 displaying functions which may be selected by a user. The screen 600 provides options such as “search events” 604, “search professionals or influencers” 608, and “network with others” 612. FIG. 5B illustrates one form of display 630 generated in response to the election of “search event” 604. In one embodiment the display 630 may comprise the screen 220 of FIG. 3A.

Alternatively, the display 630 may comprise optional forms of displays. A screen portion 640 may display groups of events 170, and fields 642 may include identification of different events 170 and include a link to the screen 220 of the GUI 150 (FIG. 3A). In response to selection of an event 170, the fields 642 could comprise an illustration 650. Illustration 650 could comprise a photograph of a celebrity, a publicity photograph for an event, or other illustration. Field 652 lists a title. Field 654 lists a brief description. Within field 654, a details option button 660 is included which can be selected by a user to obtain more detailed information. Field 662 comprises a date and time for the event. Field 664 lists whether the event has a fixed price or is an auction, and may state an opening price for an auction.

Selecting the “search professionals or influencers” option 608 leads to screen 680 illustrated in FIG. 5C. The display in screen 680 includes descriptions 684, each describing a professional person or influencer. The screen 684 may include curriculum vitae, resume, and offerings from the influencers for prospective students.

Selecting the “network with others button” 612 invokes selection of a screen 700 in FIG. 5D. Screen 700 includes a questionnaire 704 for the seeker 10 regarding attributes of a person with whom to network. Field 708 lists attributes desired by the seeker 10 and field 710 lists ranges of variation from the desired attribute that are acceptable. In field 720, the corresponding attributes of the seeker 10 are filled in.

An account database is set up. Accounts may comprise enterprise accounts, seeker accounts, provider accounts, and other accounts to suit particular needs. Each user 50 is assigned an account page which is accessible by both the user 50 and the administrator 120.

Additional software and procedures are provided via the server 130. A first facility is “create a public personal profile.” Each user 50 enters specific information intended to be seen by others. Non-public profiles are also provided. The non-public profiles may take many forms such as professional profile, talent profile, mentor profile, and seeker profile. These profiles include information that enables the system administrator 120 to perform administration functions. The profile contains a category identifying the user. The server 130 will allow creation of communications sessions between permitted entities for a type of event.

The administrator 120 may establish function templates which users 50 may employ to set up various functions. For example, the administrator 120 may provide questionnaire to a mentor 36 to set up a display for a particular sort of offering and embody the information in a standard format. The administrator 120 could provide a similar function to set up a casting search.

An editable account page routine is provided with one questionnaire for seekers 10 and a different questionnaire for providers 20. Each user 50 may be given a dashboard which operates to interface with other functions. The dashboard may be provided for such interactions as messages, activity feed, calendaring upcoming events, account balance, and rewards. Messages and message details could also be provided via interfaces other than or in addition to the dashboard. Categories of dashboards may be established to suit particular needs of groups of users 50. The categories may be given names such as professional dashboard and member dashboard.

The system has a homepage and users 50 and visitors may tour the home page to learn more about functions of the system 100. Users 50 are provided with a login field in order to enter the system 100.

Event details pages are provided for users 50. Event details pages may optionally be provided for viewing by unregistered visitors. A “discover portal” may be provided to showcase events, profiles, photos, content, and more. Various filters may be set up to edit or facilitate search of information.

In this system communications sessions and paths are set up to implement events. Each event has its own respective combination of type of user at one end of a communications path and type of user at another end of a communications path. Additionally, users are provided with communications resources to view events, create events, compete for, or purchase participation in events.

What is claimed is:

1. A method for creating communications sessions in a network, the method comprising:
registering users in the network;
assigning a category to each user, each category corresponding to a set of permissible interactions;
defining events, each event being characterized by at least one category of user permitted to participate in the event;
providing users with parameters describing an event;
receiving inputs from users defining parameters;
reading inputs from the users;
selecting users to participate in an event in accordance with a rule-based matrix utilizing the inputs; and
establishing a communications session between selected users.

2. A method according to claim 1 wherein said event comprises connecting a first user in a first category and a plurality of users in a second category.

3. A method according to claim 1 wherein said rule defines a relationship of one category of users to another category of users.

4. A method according to claim 1 further comprising storing a plurality of event descriptions and associating event parameters with each event and enabling access by the users to the event parameters.

5. A non-transitory programmed medium which when executed on a digital processor causes the processor to perform the steps of:
registering users in the network;
assigning a category to each user, each category corresponding to a set of permissible interactions;
defining events, each event being characterized by at least one category of user permitted to participate in the event;
providing users with parameters describing an event;
receiving inputs from users defining parameters;
reading inputs from the users;
selecting users to participate in an event in accordance with a rule-based matrix utilizing the inputs; and
establishing a communications session between selected users.

6. A non-transitory programmed medium according to claim 5 wherein the programmed medium further causes the processor to perform the step of storing a plurality of event descriptions and associating event parameters with each event and enabling access by the users to the event parameters.
